(19) United States
(12) Patent Application Publication
(10) Pub. No.: US 2012/0117271 A1
(43) Pub. Date: May 10, 2012

(54) Synchronization of Data in a Distributed Computing Environment

(75) Inventors: Sean Patrick Kennedy, San Diego, CA (US); Gary Roberts Lyons, San Diego, CA (US); Michael Chang, San Diego, CA (US); Rommel M. Garay, San Marcos, CA (US); Edward Theodore Winter, San Diego, CA (US); Andrew Lee Lawton, San Marcos, CA (US); Fredrik Carpio, Menifee, CA (US); Adrian Crisan, San Diego, CA (US); Toyoaki Kishimoto, San Diego, CA (US)

(73) Assignee: Sony Corporation

(21) Appl. No.: 12/940,813

(22) Filed: Nov. 5, 2010

(51) Int. Cl. G06F 15/16

(52) U.S. Cl. 709/248

(57) ABSTRACT

A method for data synchronization across multiple target destinations in a computer network includes acquiring information about the target destinations, wherein: the target destinations comprises at least one of a network account in the computer network, or a target device coupled to the computer network or associated with the network account; and the acquired information includes identification information associated with the target destinations. The method may also include receiving, at a user device, data from a data source; filtering the received data based on information included in the received data and in the identification information; identifying, based on the filtering, a selected target destination for receiving the filtered data; and transmitting the filtered data to the identified selected target destination.

### TECHNICAL FIELD

The present disclosure relates to methods and systems for synchronization of data from a device to multiple locations in a distributed data network environment such as, for example, a cloud computing environment.

### BACKGROUND

In a distributed computing environment such as, for example, a cloud computing environment, data is stored at distributed, multiple locations. Presently, there is no easy way to synchronize data from a local device to multiple locations in the “cloud” or to other devices globally.

### SUMMARY

The present disclosure includes an exemplary method for data synchronization across multiple target destinations in a computer network. Embodiments of the method include acquiring information about the target destinations, wherein: the target destinations comprises at least one of a network account in the computer network, or a target device coupled to the computer network or associated with the network account; and the acquired information includes identification information associated with the target destinations. Embodiments of the method may also include receiving, at a user device, data from a data source; filtering the received data based on information included in the received data and in the identification information; identifying, based on the filtering, a selected target destination for receiving the filtered data; and transmitting the filtered data to the identified selected target destination.

An exemplary system in accordance with the present disclosure comprises a user device to receive data and an auto-synchronization engine coupled to the user device. The auto-synchronization engine acquires information about target destinations, wherein: the target destinations comprises at least one of: a network account in the computer network, or a target device coupled to the computer network or associated with the network account; and the acquired information includes identification information associated with the target destinations. In some embodiments, the auto-synchronization engine also filters the received data based on information included in the received data and the identification information; identifies, based on the filtering, a selected target destination for receiving the filtered data; and transmits the filtered data to the identified selected target destination.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system consistent with the invention.

FIG. 2 is a flow chart illustrating an exemplary embodiment for data synchronization.

FIG. 3 is a flow chart illustrating an exemplary embodiment for creating a distribution list.

FIG. 4 is a flow chart illustrating an exemplary embodiment for data synchronization using a graphical user interface.

FIG. 5 illustrates an exemplary graphical user interface for data synchronization.

FIG. 6 is a flow chart illustrating an exemplary embodiment for pipe-aware data synchronization.

FIG. 7 is a flow chart illustrating an exemplary embodiment for device-aware data synchronization.

FIG. 8 is a block diagram illustrating one exemplary embodiment of an auto-sync engine 106 in the exemplary system 100 of FIG. 1.

### DETAILED DESCRIPTION

Reference will now be made in detail to the exemplary embodiments illustrated in the accompanying drawings. Wherever possible, the same reference numbers will be used throughout the drawings to refer to the same or like parts.

Methods and systems disclosed herein address the above described needs. For example, exemplary embodiments may be used to automatically identify destinations and synchronize data from a local device to the multiple, identified destinations in one or more computer networks.

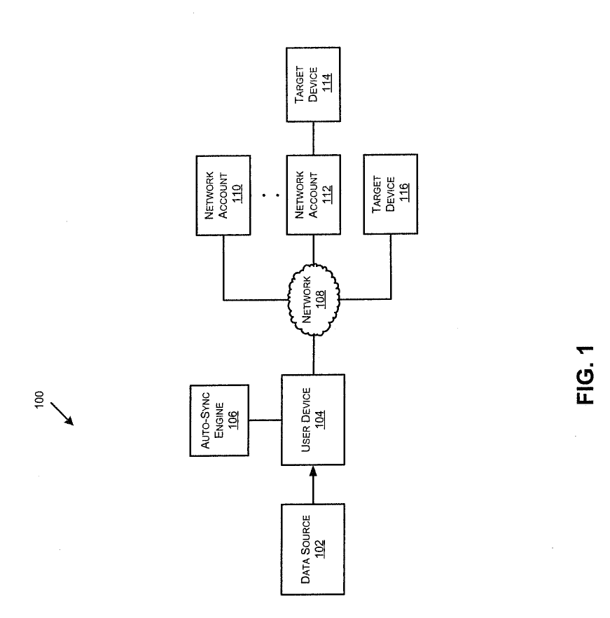

FIG. 1 illustrates a block diagram of an exemplary system 100 consistent with the presently-claimed invention. As shown in FIG. 1, exemplary system 100 may comprise a data source 102, a user device 104, an auto-sync engine 106, one or more network accounts 110-112, and one or more target devices 114-116, operatively connected to one another and via one or more networks (e.g., network 108) or any type of communication link that allow transmission of data from one component to another. The network may include Local Area Networks (LANs) and/or Wide Area Networks (WANs), and may be wireless, wired, or a combination thereof.

Data source 102 can be any type of storage medium capable of storing data such as, e.g., media data including audio and/or visual content, text content, combinations thereof, or any other types of data. For example, data source 102 can be provided as a video CD, DVD, Blu-ray disc, hard disk, magnetic tape, flash memory card/drive, volatile or non-volatile memory, holographic data storage, and any other type of storage medium. Data source 102 can also be a data capturing device or computer capable of providing data to user device 104. For example, data source 102 can be a camera capturing imaging data and providing the captured imaging data to user device 104.

As another example, data source 102 can be a web server, an enterprise server, or any other type of computer server. Data source 102 can be a computer programmed to accept requests (e.g., HTTP, or other protocols that can initiate data transmission) from user device 104 and to serve user device 104 with requested data. In addition, data source 102 can be a broadcasting facility, such as free-to-air, cable, satellite, and other broadcasting facility, for distributing data.

User device 104 can be, for example, a computer, a personal digital assistant (PDA), a cell phone or smartphone, a laptop, a desktop, a media content player, a set-top box, a television set including a broadcast tuner, a video game controller, or any electronic device capable of accessing a data network and/or providing data. User device 104 may include software applications that allow user device 104 to communicate with and receive data from a network or local storage medium. As mentioned above, user device 104 can receive data from data source 102, examples of which are provided above.

Auto-sync engine 106 can be implemented as a software program executing in a processor and/or as hardware that performs data synchronization. Auto-sync engine 106 can synchronize data from user device 104 to one or more destinations. The destinations can include, for example, one or more network accounts (e.g., network accounts 110, 112) in one or more computer networks, one or more target devices (e.g., target devices 114, 116), or other locations or devices accessible to the user device. The data synchronization will be further described below.

Network 108 may be one or more computer networks, and can include or connect to one or more network accounts 110, 112 and/or one or more target devices 114, 116. While FIG. 1 shows only two network accounts 110, 112 and two target devices 114, 116, it should be understood that more of each could be used. Network accounts 110, 112 can be, for example, user accounts associated with network 108, or identifiers referring to network locations or storage spaces in network 108. In some embodiments, the one or more network accounts may be associated with one or more storage spaces in network 108.

Target devices 114, 116 can be, for example, computers, personal digital assistants (PDAs), cell phones or smartphones, laptops, desktops, media content players, set-top boxes, television sets including a broadcast tuner, video game controllers, or any electronic device capable of accessing a data network and/or receiving data. In some embodiments, target devices 114, 116 can be display devices such as, for example, televisions, monitors, projectors, digital photo frames, display panels, and any other display devices. In some embodiments, some of network accounts 110, 112 may be associated with or attached to some of target devices 114, 116. For example, target devices 114 is associated with or attached to network account 112. In some embodiments, network accounts 110, 112 and target devices 114, 116 can request synchronization of data and/or receive the data from user device 104 and/or auto-sync engine 106.

In some embodiments, network 108 may include one or more Internet social networks such as, for example, FLICKR®, FACEBOOK, MYSPACE, TWITTER, LINKEDIN®, etc., and network accounts 110, 112 may be accounts in the one or more Internet social networks. A user of user device 104 may be associated with network accounts 110, 112 through the one or more Internet social networks. For example, one or more of network accounts 110, 112 may be contacts of the user in the one or more Internet social networks.

While shown in FIG. 1 as separate components that are operatively connected, any or all of data source 102, user device 104, and auto-sync engine 106 may be co-located in one device. For example, data source 102 can be located within or form part of user device 104, and auto-sync engine 106 can be located within or form part of data source 102 or user device 104. It is understood that the configuration shown in FIG. 1 is for illustrative purposes only. Certain components or devices may be removed or combined and other components or devices may be added.

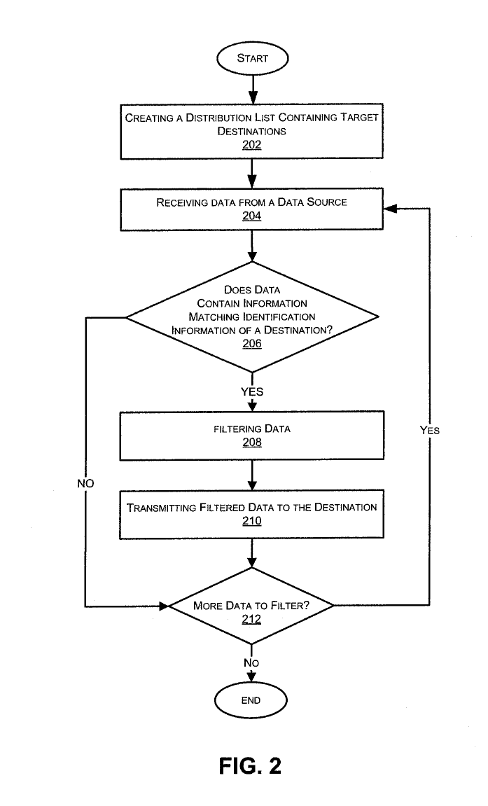

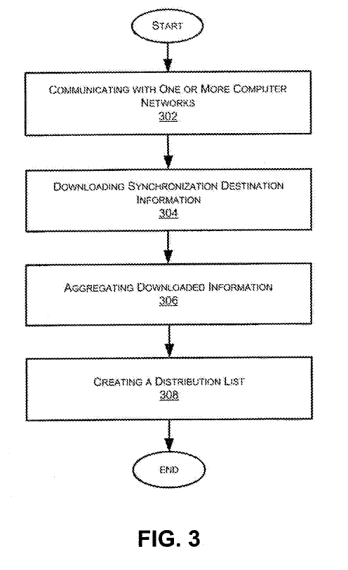

FIG. 2 is a flow chart illustrating an exemplary method for data synchronization. As shown in FIG. 2, before synchronizing data from a user device to one or more destinations, a distribution list containing multiple destinations may be created (step 202). For example, FIG. 3 is a flow chart illustrating an exemplary method for creating a distribution list. As illustrated in FIG. 3, an auto-sync engine can communicate with one or more computer networks such as, e.g., one or more Internet social networks (step 302). Authentication information, such as a login identification and a password, may be provided to facilitate the communication. Once communication with a network is established, the auto-sync engine can download synchronization destination information such as, e.g., contact information in an Internet social network joined by a user, target device information, and/or information about other locations accessible to the user device from the network (step 304). The information downloaded from each network can then be aggregated and/or analyzed (step 306).

Based on the aggregated information, a distribution list can be created (step 308). The distribution list may include, for example, network accounts (e.g., Internet social network contacts), target devices, or other locations accessible to the user device. In some embodiments, the distribution list may include one or more sub-lists such as, e.g., a friend list consisting of contacts and/or target devices marked as friends, or a family list consisting of contacts and/or target devices marked as family. In some embodiments, the downloaded synchronization destination information may be used to update an existing distribution list.

In some embodiments, destinations on the distribution list may have identification information associated with, referring to, or identifying the destinations. The identification information may include one or more of the following such as, for example, a name (e.g., Bob, Bob's cell phone, etc.), classification information (e.g., a friend, a classmate, or a family member), geographical information, an image of a person's face, a voice of a person, or other information identifying the destination. In some embodiments, the auto-sync engine can configure the identification information using data controlled by the user or by members of the distribution list. For example, the auto-sync engine can download and analyze content items posted to the user or his/her contacts' Internet social network locations, and extract information that may be used to associate the content items with any of the destinations. Based on the extracted information, the identification information of the associated destinations can be updated, thereby improving the chance or probability that data from the user device will be synchronized with the right destinations.

Referring back to FIG. 2, in step 204, data is received from a data source (step 204). The auto-sync engine can compare information included in the received data with the identification information described above. Based on the comparison, the auto-sync engine can determine whether the information included in the received data contains or matches any identification information associated with, referring to, or identifying) one or more destinations (step 206). The information to be matched may take a form of, for example, metadata (e.g., tagging information such as geo-tagging, social networking tagging, or other data-tagging), part of the received data (e.g., an image for face recognition or a voice for voice recognition, etc.), content item name, etc. If no matching information is found, the process proceeds to step 212 to check for more data.

If matching information is found, the auto-sync engine filters the received data based on the matching information and/or the identification information (step 208). In some embodiments, step 206 may be part of the filtering process or an additional step may be included to identify one or more destinations. In some embodiments, the filtering process may also include, for example, associating the received data with one or more destinations in the distribution list, and/or classify the received data as one to be sent to one or more destinations in the distribution list.

In some embodiments, based on the association or classification, the filtered data may be configured to include access permission metadata granting certain permissions to certain people or a group of people. For example, if the data to be synchronized is associated with family contacts of Internet social networks, the filtered data can be configured to include permission metadata consistent with conventions of the destination network. The filtered data can then be posted to a public network location but can only be assessed in accordance with the permissions.

In some embodiments, during the filtering process the information included in the received data may be updated, and the filtering process can be performed on the received data based on the updated information. For example, additional metadata or tagging information may be added to the received data if the received data contains information linked to a particular destination, e.g., a data tag “for Bob Smith” may be added if a face image linked to an Internet social network contact “Bob Smith.”

Also, geographical metadata or tagging information may be added to the received data or may be updated when synchronizing from a user device that has Global Positioning System (“GPS”) capability. For example, when receiving a media content (e.g., images or videos) from an image capturing device having the GPS capability, if the image capturing device had captured information of a place where the media content was captured, a GPS or geographical data tag, e.g., a data tag with the string of “San Diego Zoo, San Diego, Calif.,” may be attached to or included in the received media content.

Further, the auto-sync engine may provide a user interface that allows a user to update data-tagging, change content item names, or include additional information in the received data's metadata or tags. For example, a graphical user interface may be provided for a user to update the data tag of the above example to include additional information, e.g., “Zebra, San Diego Zoo, San Diego, Calif., Sep. 15-2010, by Bob Smith.” Accordingly, based on the updated information included in the received data, the auto-sync engine may automatically filter the received data by associating the received data with an Internet social network contact who is called “Bob Smith,” who is located in San Diego, Calif., who visited the San Diego Zoo with the user, who likes zebra or other similar animals, or etc. The auto-sync engine may also associate the received data with the contact's one or more associated target devices.

In some embodiments, during the filtering process the received data may be converted into a new content item or merged with other content items before being transmitted to a target destination. For example, the auto-sync engine may provide an interface prompting the user to choose or decide whether to merge the data or content items into a movie or a photo collage. Depending on the user's selection, a movie or a photo collage can be automatically created. The auto-sync engine can then prepare for transmitting the merged content items to the target destination.

Referring back to FIG. 2, in step 210, the auto-sync engine transmits the filtered data to the target destination. The process then goes to step 212 to check if there is more data to be filtered. If not, the process ends. If there is more data to be filtered, the process goes to step 204 to receive more data.

In some embodiments, the data synchronization process can cause the transmitted data to be populated and displayed on a target device automatically. For example, the user does not need to upload media content (e.g., photos or videos) to a storage site and then have friends or family members download it manually. Instead, the media content can be sent directly from device to device, for example, sending a photo from a user device directly to a target device (e.g., a digital photo frame) on the other side of the country, so the media content can be automatically populated and shown on the target device. This can be done, for example, by enabling an auto-start live sync function which can download data from a data source, automatically filter the data, and upload the filtered data to the cloud or to the target device across country.

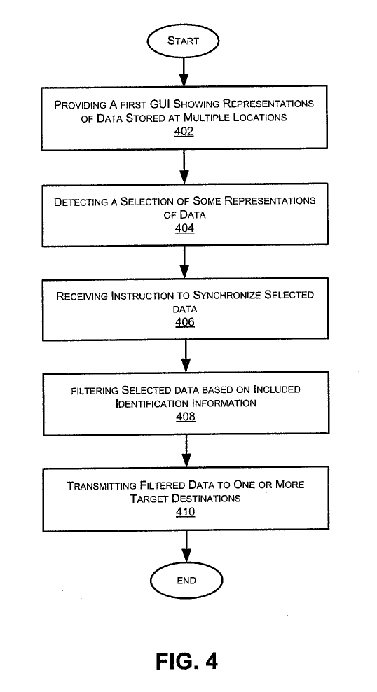

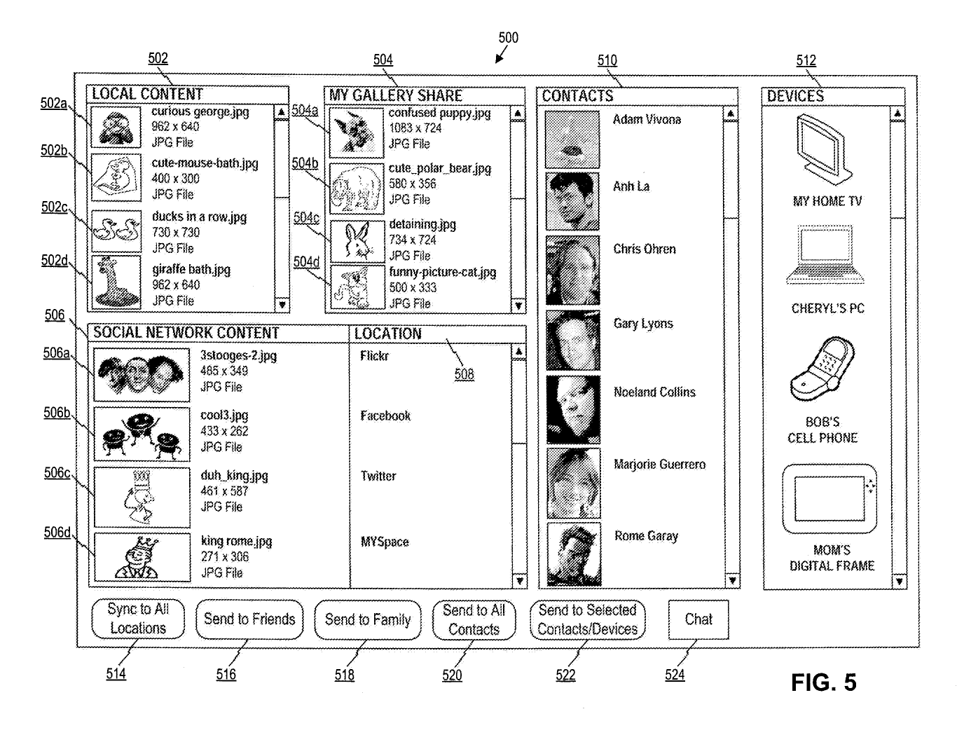

FIG. 4 is a flow chart illustrating an exemplary method for data synchronization using a graphical user interface (“GUI”). As shown in FIG. 4, in step 402, a first GUI can be provided at a user device that shows representations of data stored at multiple locations local to and/or remote from the user device. The representations can be graphical objects, sequences of characters, or combinations thereof. For example, FIG. 5 illustrates an exemplary GUI 500 for data synchronization.

The user can use the GUI to manage and share the data. For example, the user can use a pane-style viewer, e.g., GUI 500 shown in FIG. 5, for managing multiple synchronization accounts and cloud storages, sites, or devices. GUI 500 shows icons 502a-d representing local content 502 from a local system, items 504a-d of gallery share content 504 for sharing with Internet social network contacts, and items 506a-d of Internet social network content 506 from multiple Internet social network locations 508. GUI 500 also shows a list of Internet social network contacts 510, target devices 512, and action buttons 514-524.

In some embodiments, the auto-sync engine can download content posted to or stored at the user and/or his/her contacts' Internet social networks, attached devices, or any network locations. The downloaded content can be aggregated, classified, and listed, as shown on GUI 500. In some embodiments, the auto-sync engine may manage and share the content by providing links to the content items but without downloading them. The user can edit the content. For example, the user can copy or move a content item from one location/device to another location/device, delete a content item, rename a content item, edit metadata or tags of a content item, etc. In some embodiments, for example, the user can click an action button 514 as shown in FIG. 5 to synchronize selected content or all content from one location/device to all other locations/devices.

Referring back to FIG. 4, an auto-sync engine can detect that a user selects some representations of data (step 404), and receive an instruction from the user to synchronize the selected data (step 406). The user can give the instruction by any action commanding data synchronization, for example, by performing a drag-and-drop action, clicking an action button, etc. Once receiving the instruction, the auto-sync engine can filter the selected data (step 408), and then transmit the filtered data to one or more target destinations (step 410), as described above.

In some embodiments, a user can select one or more listed content items by, for example, using an GUI, such as GUI 500 shown in FIG. 5. Then, the user can send the selected content items by dragging and dropping the selected content items onto a target graphical object representing an Internet social network contact or a target device listed on the GUI. For example, a “Facebook on TV” function may be enabled to create a media content such as, e.g., a photo collage, a screen saver, or a movie, from one or more social network content items, and automatically send or project the dragged-and-dropped content items to a target device such as, e.g., a television, for display.

In some embodiments, for example, a user may chat with one of his/her contacts using an instant message interface. The instant message interface (not shown in FIG. 5) may be located within a data synchronization GUI, such as GUI 500 shown in FIG. 5, or may be a separate GUI. For example, a chat window can be opened by selecting a contact and clicking a chat button 524. During the chatting, the user may decide to share his data with the current contact. The user can select one or more listed content items, and drag and drop the selected content items onto the instant message interface.

In some embodiments, for example, by using an GUI, such as GUI 500 shown in FIG. 5, a user can select one or more listed content items, and click an action button 516 to send the selected content items to friends, that is, contacts and/or associated target devices marked as friends. The user can also click an action button 518 to send the selected content items to family, that is, contacts and/or associated target devices marked as family. In addition, the user can click an action button 520 to send the selected content items to all contacts and/or associated target devices. Further, the user can select one or more target graphical objects representing Internet social network contacts or target devices listed on the GUI, and then click an action button 522 to send the selected content items to the selected contacts and/or target devices. In some embodiments, if no individual content items are selected, all listed content items may be regarded as being selected for synchronization or transmission.

After detecting the user's drag-and-drop action or click-send-button action, the auto-sync engine can perform the above-described data filtering process, and transmit the filtered data to the intended destination(s) such as, e.g., intended social network contact(s) and/or target device(s).

In some embodiments, the auto-sync engine can manage a storage space of a destination, provide a notification or an alert to a user, and prompt the user to choose or confirm an action. For example, using an GUI, such as GUI 500 shown in FIG. 5, the user can use the above-described method to send a media content (e.g., a video, photo, slide-show, or music clip) from any network location, attached device, or social networking site to a target destination. In some embodiments, when transmitting the content, the auto-sync engine can prompt the user to choose whether to store the content as permanent or temporary content. Permanent content may never expire and cannot be overwritten, whereas temporary content may expire after some period of time and can be overwritten after expiration. Also, if detecting that some stored content on a target destination is about to expire or be overwritten, the auto-sync engine can alert the user and prompt the user to confirm the overwriting.

In addition, in some embodiments, if detecting that the available storage space of a target destination is below a threshold (e.g., 15% space remaining), the auto-sync engine can alert the user (or a contact who manages the destination) to free some storage space. Further, in some embodiments, when transmitting the content, the auto-sync engine can prompt the user to choose to store the content in a particular location (e.g., a particular folder or a particular category such as, e.g., favorite TV shows or upcoming movies) on the target destination.

It is understood that functions and graphical components shown in FIG. 5 are for illustrative purposes only. Certain functions or graphical components may be removed, combined, or rearranged, and other functions or graphical components may be added.

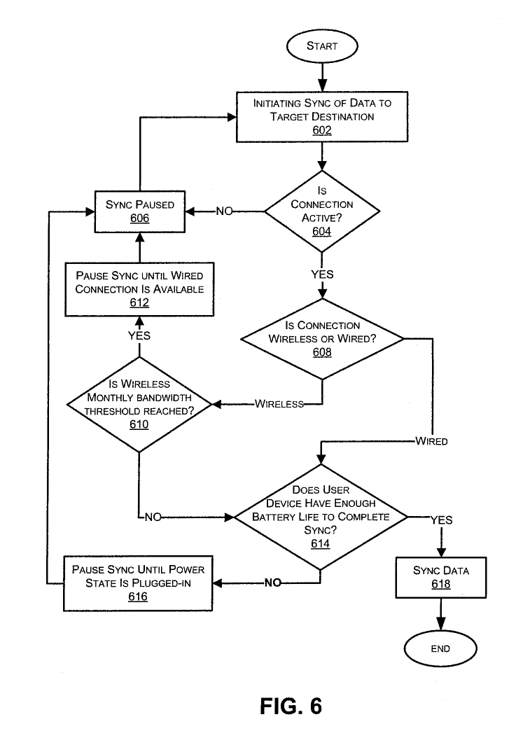

FIG. 6 is a flow chart illustrating an exemplary embodiment for “pipe-aware” data synchronization, that is, data synchronization in which the process varies, depending on the capacity of a communication channel, or “pipe,” for example, broadband connection, wireless connection, dial-up connection, etc. In some embodiments, an auto-sync engine can determine a status of a communication pipe used for performing the data synchronization and transmitting the data, e.g., a status of a connection and/or a user device, and then decide whether to continue or complete the data synchronization. For example, in some embodiments, an auto-sync engine can detect that data transmission from a user device is on a slow connection, or a connection in which a bandwidth usage or cost limit has been reached, and then wait for a faster or less expensive connection. In some embodiments, the auto-sync engine can also detect that available resources on the user device cannot allow for completing the data synchronization. The auto-sync engine will then wait for enough resources to become available.

As illustrated in FIG. 6, after initiating synchronization of data from a user device to a target destination via a computer network (step 602), an auto-sync engine can check whether a connection to the computer network is active (step 604). If no active connection is established, the auto-sync engine can pause or stop the data synchronization process (step 606). If an active connection is established, the auto-sync engine can check whether the active connection is a fast or slow connection, or a connection with or without a bandwidth usage or cost limit (step 608). If it is a slow connection or a connection with a bandwidth usage or cost limit (e.g., a wireless connection with a 100-megabyte monthly data upload usage limit), the auto-sync engine can further check whether a monthly bandwidth usage or cost threshold is reached (step 610). If the threshold is reached, any data transmission over the connection may be prohibited as being too expensive. In that case, the auto-sync engine can pause or stop the data synchronization process until a fast connection or a connection without the limit (e.g., a wired connection) becomes available (step 612).

If a fast connection (e.g., a wired connection) or a connection without a bandwidth usage or cost limit is established, the auto-sync engine can determine whether the user device has enough resources available (e.g., battery life) to complete the data synchronization (step 614). If not, the auto-sync engine can pause or stop the data synchronization process until enough resources (e.g., power supply becoming plugged-in) are available (step 616). If there are enough resources available, the auto-sync engine can complete the above-described data synchronization (step 618). Of course other types of resources, in addition to battery life, may be analyzed in this manner.

In some embodiments, the auto-sync engine may be able to acquire the pipe status of the destination side. Based on the pipe status on the destination side, the auto-sync engine can perform the above-described pipe-aware data synchronization.

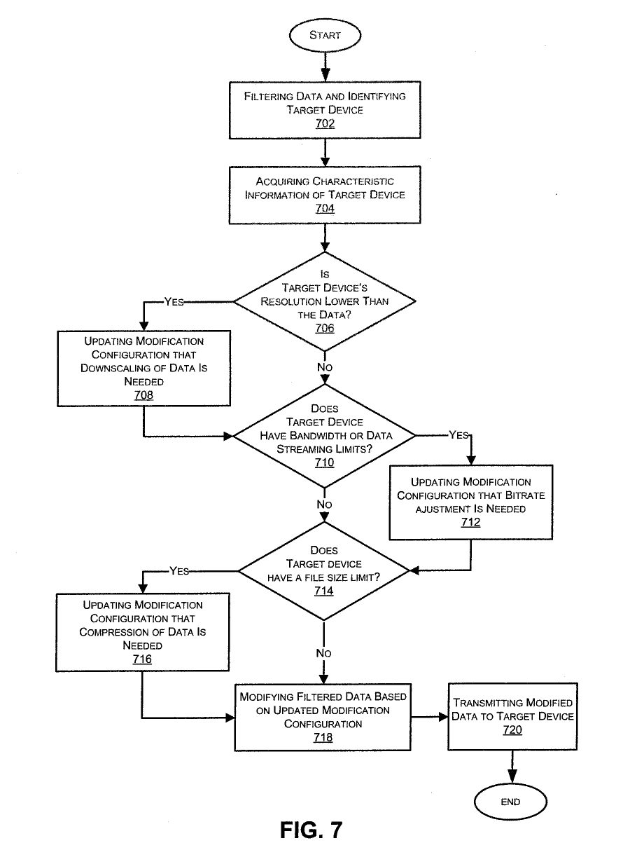

FIG. 7 is a flow chart illustrating an exemplary embodiment for device-aware data synchronization. In some embodiments, before sending data to a target destination, an auto-sync engine may modify (e.g., scale or optimize, etc) the data based on characteristic information of the target destination. The characteristic information can include, for example, a display screen size, a maximum resolution, an acceptable file size (by a device or a service), a bandwidth limit, etc. For example, based on the characteristic information, the auto-sync engine can auto-shrink a projection size of the data for a target device with a small display screen, downscale a resolution of the data to a lower resolution matching a maximum resolution of a target device, compress the data to a smaller size acceptable by a target device or a service (e.g., an Internet service), adjust bitrate (i.e., data transfer rate) of the data to match a bandwidth of a target device or a service, and etc. For example, sending a full high-definition video to a handheld device may mean adjusting not only the image projection size but also the file size itself. By performing the data modification (e.g., scaling, optimization, etc.), the auto-sync engine can send only as much data as needed to display the data by a destination, and/or send as much data as that a destination can accept. The data modification can reduce data transmission time, save bandwidth, and improve user experiences on both data transmission and destination sides.

For example, as shown in FIG. 7, in step 702, an auto-sync engine can perform the above-described filtering process on data to be synchronized, and identify a target device for receiving the filtered data. The auto-sync engine can acquire characteristic information of the target device (step 704). In some embodiments, the auto-sync engine can query the target device for the characteristic information. In some embodiments, the characteristic information may have been collected and stored when creating an above-described distribution list. The auto-sync engine can retrieve the stored characteristic information, without querying the target device.

After obtaining the characteristic information, the auto-sync engine can compare the characteristic information with information about the filter data. Based on the comparison, the auto-sync engine can determine whether to modify the filtered data. For example, the auto-sync engine can check whether the target device's resolution is lower than the resolution of the filtered data (step 706). If so, the auto-sync engine can update modification configuration that downscaling of the filtered data is needed (step 708). If the target device's resolution is not lower than the filtered data, the auto-sync engine can check whether the target device has a bandwidth or data streaming limit (step 710). If so, the auto-sync engine can update the modification configuration that bitrate adjustment is needed (step 712).

If the target device does not have a bandwidth or data streaming limit, the auto-sync engine can check whether the target device has a file size limit and a size of the filtered data reaches that limit (step 714). If either of the checks is positive, the auto-sync engine can update the modification configuration that compression of the filtered data is needed (step 716). In some embodiments, a target device may have a file type limitation. For example, the target device may not accept streaming data due to its big file size.

If the target device does not have a file size limit or the size of the filtered data does not reach that limit, the process can proceed to step 718 for data modification. Based on the updated modification configuration, the auto-sync engine can perform the above-described data modification on the filtered data (step 718), and transmit the modified data to the target device (step 720). The method then ends.

In some embodiments, if the data modification cannot resolve any of the above-described limitations imposed by the characteristics of the target device, the auto-sync engine may alert the user. The auto-sync engine may also prompt the user to confirm data transmission or to choose an alternative action.

It is understood that the above-described exemplary process flows in FIGS. 2-4, 6, and 7 are for illustrative purposes only. Certain steps may be deleted, combined, or rearranged, and additional steps may be added.

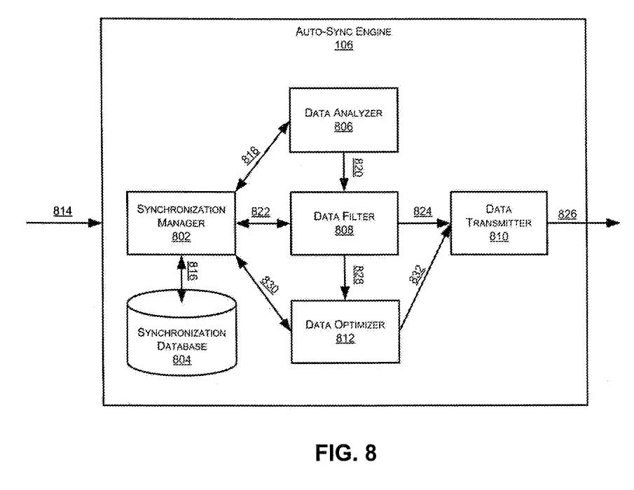

FIG. 8 is a block diagram illustrating one exemplary embodiment of an auto-sync engine 106 in the exemplary system 100 of FIG. 1. As shown in FIG. 8, auto-sync engine 106 may include a synchronization manager 802, a synchronization database 804, a data analyzer 806, a data filter 808, a data transmitter 810, and a data optimizer 812.

It is understood that components of auto-sync engine 106 shown in FIG. 8 are for illustrative purposes only. Certain components may be removed or combined and other components may be added. Also, one or more of the components depicted in FIG. 8 may be implemented in software on one or more computing systems. For example, such components may comprise one or more software applications, which may comprise one or more computer units including storage devices containing computer-readable instructions which, when executed by a processor, cause a computer to perform steps of a method. Computer-readable instructions may be stored on a tangible non-transitory computer-readable medium, such as a solid-state memory or disk memory. Alternatively, one or more of the components depicted in FIG. 8 may be implemented in hardware components or combinations of hardware and software such as, for example, ASICS, special purpose computers, or general purpose computers.

With reference to FIG. 8, auto-sync engine 106 receives data to be synchronized from a data source (814). In some embodiments, synchronization manager 802 may store the received data in synchronization database 804 (816), or pass the received data to data analyzer 806 for further processing (818). In some embodiments, the data may have been received and stored in synchronization database 804, and can be retrieved by synchronization manager 802 for synchronization (step 816).

Synchronization manager 802 can manage data to be synchronized, configure and provide information facilitating data modification, and coordinate the data modification. For example, synchronization manager 802 can create and configure a distribution list containing target destinations for receiving synchronization data, acquire and configure status information of a user device and/or target destinations, and acquire and configure characteristic information, data modification configuration, and identification information for target destinations, as described above. Also, in some embodiments, synchronization manager 802 can manage data to be synchronized by, for example, gathering and aggregating the data from various locations or devices, updating metadata/tagging information of the data, editing the data, configuring access permission information, and etc., as described above. In some embodiments, synchronization manager 802 can provide a GUI to perform one or more of the above-described functions. In some embodiments, synchronization manager 802 may utilize synchronization database 804 for storing the above-described data and information.

In some embodiments, synchronization manager 802 can be employed to acquire status information of a user device used for sending the filtered data to the target destination. The status information can be acquired from the user device or from synchronization database 804 (816). Based on the acquired status information, synchronization manager 802 can coordinate performing the above-described pipe-aware data synchronization. In some embodiments, synchronization manager 802 can coordinate performing the above-described pipe-aware data synchronization based on status information of the target destination.

Synchronization database 804 can be used for storing a collection of information related to data synchronization. The storage can be organized as a set of queues, a structured file, a relational database, an object-oriented database, or any other appropriate database. Computer software, such as a database management system, may be utilized to manage and provide access to the data stored in synchronization database 804. Synchronization database 804 may store data to be synchronized and any information that can facilitate data modification, as described above.

In some embodiments, data analyzer 806 can be employed to analyze the received data, and determine whether the received data contains any information matching identification information associated with a target destination, as described above. In some embodiments, data analyzer 806 can identify the target destination based on the determination. The identification information can be acquired from, e.g., synchronization database 804 directly or through synchronization manager 802 (816 and 818). In some embodiments, data analyzer 806 may extract the matching information, and pass it along with the analyzed data to data filter 808 for further processing (828).

Based on the matching information and the identification information received from data analyzer 806 or synchronization database 804 (816 and 822), data filter 808 can perform the above-described data filtering process to the analyzed data. The filtered data is passed to data transmitter 810 for transmission (824 and 826).

In some embodiments, data optimizer 812 can also be employed to acquire characteristic information of the target destination. The characteristic information can be acquired from the target destination or from synchronization database 804 directly or through synchronization manager 802 (816 and 830). Based on the acquired characteristic information, data optimizer 812 can perform the above-described device-aware data modification to the filtered data. Data optimizer 812 can then pass the modified data to data transmitter 810 for transmission (832 and 826).

During the above-described data synchronization process, each component of auto-sync engine 106 may store its computation/determination results in synchronization database 804 for later retrieval or training purpose. Based on the historic data, auto-sync engine 106 may train itself for improved performance on filtering the data and sending the data to right destinations.

The methods disclosed herein may be implemented as a computer program product, i.e., a computer program tangibly embodied in a non-transitory information carrier, e.g., in a machine-readable storage device, or a tangible non-transitory computer-readable medium, for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

A portion or all of the methods disclosed herein may also be implemented by an application-specific integrated circuit (ASIC), a field-programmable gate array (FPGA), a complex programmable logic device (CPLD), a printed circuit board (PCB), a digital signal processor (DSP), a combination of programmable logic components and programmable interconnects, a single central processing unit (CPU) chip, a CPU chip combined on a motherboard, a general purpose computer, or any other combination of devices or modules capable of performing data synchronization disclosed herein.

In the preceding specification, the invention has been described with reference to specific exemplary embodiments. It will, however, be evident that various modifications and changes may be made without departing from the broader spirit and scope of the invention as set forth in the claims that follow. The specification and drawings are accordingly to be regarded as illustrative rather than restrictive. Other embodiments of the invention may be apparent to those skilled in the art from consideration of the specification and practice of the invention disclosed herein.

What is claimed is:

1. A computer-implemented method for data synchronization across multiple target destinations in a computer network, the method comprising:
acquiring information about the target destinations, wherein:
the target destinations comprises at least one of:
a network account in the computer network; or
a target device coupled to the computer network or associated with the network account; and
the acquired information includes identification information associated with the target destinations;
receiving, at a user device, data from a data source;
filtering the received data based on information included in the received data and in the identification information;
identifying, based on the filtering, a selected target destination for receiving the filtered data; and
transmitting the filtered data to the identified selected target destination.

2. The method of claim 1, wherein filtering the received data comprises:
comparing the information included in the received data with the identification information associated with the target destinations,
wherein:
the identification information includes at least one of:
geographical identification information,
an image of a person's face,
a voice of a person, or
information referring to any of the target destinations;
determining whether the information of the received data matches identification information associated with any of the target destinations;
identifying the selected target destination based on the determination; and
associating the received data with the identified selected target destination.

3. The method of claim 1, wherein filtering the received data comprises:
receiving user input to manually update the information included in the received data; and
filtering the received data based on the updated information and the identification information associated with the target destinations.

4. The method of claim 1, wherein filtering the received data comprises:
automatically updating the information included in the received data; and
filtering the received data based on the updated information and the identification information associated with the target destinations.

5. The method of claim 1, further comprising:
configuring access permission metadata of the filtered data to provide criteria such that access to the transmitted data is provided only to users meeting the criteria.

6. The method of claim 1, further comprising:
receiving user input to select creation of a first content item by one of converting content items of the filtered data into a new format or merging the content items of the filtered data with a second content item;
creating the first content item according to the user selection; and
transmitting the created first content item to the identified selected target destination.

7. The method of claim 1, further comprising:
acquiring characteristics information of the identified selected target destination, wherein
the acquired characteristics information includes at least one of:
a display screen size,
a maximum resolution,
an acceptable file size, or
a bandwidth limit;
modifying the filtered data based on the acquired characteristics information; and
transmitting the modified data to the identified selected target destination.

8. The method of claim 1, further comprising:
acquiring status information of the user device or the identified selected target destination;
determining, based on the acquired status information, whether a restriction threshold is reached; and
performing the data synchronization if the determination shows that the threshold is not reached,
wherein the restriction threshold is related to a connection bandwidth or available resources.

9. The method of claim 1, further comprising:
initiating display of the transmitted data at the identified selected destination.

10. The method of claim 1, further comprising:
providing, at the user device, a first graphical user interface for displaying representations of the received data;
detecting a selection of a subset of the representations of the data;
receiving an instruction from a user to transmit selected data represented by the selected subset of the representations to a selected target destination;
after receiving the instruction, filtering the selected data based on information included in the selected data and identification information associated with the at least one of target destinations; and
transmitting the filtered data to the selected target destination.

11. The method of claim 10, further comprising:
receiving from the user a selection of a target graphical object representing the selected target destination, wherein:
the target graphical object is displayed within the first graphical user interface; and
transmitting the filtered data to the selected target destination represented by the selected target graphical object.

12. The method of claim 10, wherein receiving an instruction from the user to transmit the selected data to the selected target destination comprises:
detecting that the selected subset of the representations of the data is dragged over and dropped onto a target graphical object linking to the selected target destination.

13. The method of claim 12, wherein the target graphical object is within a second graphical user interface facilitating communication between the user and the selected target destination.

14. The method of claim 10, wherein receiving an instruction from the user to transmit the selected data to the selected target destination comprises:
detecting that the user presses a graphical action object instructing to transmit the selected data to the selected target destination.

15. The method of claim 10, further comprising:
receiving user input to edit the received data listed in the first graphical user interface.

16. An apparatus for synchronizing data across multiple target destinations in a computer network, the apparatus comprising:
a synchronization manager to acquire information about the target destinations, wherein:
the target destinations comprises at least one of:
a network account in the computer network; or
a target device coupled to the computer network or associated with the network account; and
the acquired information includes identification information associated with the target destinations;
a data analyzer to determine whether information included in the received data matches identification information associated with a selected target destination;
a data filter to filter the received data based on the determination; and
a data transmitter to transmit the filtered data to the selected target destination.

17. The apparatus of claim 16, wherein the synchronization manager:
acquires status information of the apparatus or the selected target destination;
determines, based on the acquired status information, whether a restriction threshold is reached, wherein:
the restriction threshold is related to a connection bandwidth or available resources; and
instructs the data transmitter to transmit the filtered data based on the determination.

18. The apparatus of claim 16, further comprising a data optimizer for:
acquiring characteristics information of the selected target destination, wherein:
the acquired characteristics information includes at least one of:
a display screen size,
a maximum resolution,
an acceptable file size, or
a bandwidth limit;
modifying the filtered data based on the acquired characteristics information; and
instructing the data transmitter to transmit the modified data to the selected target destination.

19. A system comprising:
a user device to receive data; and
an auto-synchronization engine coupled to the user device to acquire information about target destinations, wherein:
the target destinations comprises at least one of:
a network account in the computer network, or
a target device coupled to the computer network or associated with the network account; and
the acquired information includes identification information associated with the target destinations;
filter the received data based on information included in the received data and the identification information;
identify, based on the filtering, a selected target destination for receiving the filtered data; and
transmit the filtered data to the identified selected target destination.

20. A non-transitory computer-readable medium storing instructions that, when executed, cause a computer to perform a method for data synchronization across multiple target destinations in a computer network, the method comprising:
acquiring information about the target destinations, wherein:
the target destinations comprises at least one of:
a network account in the computer network, or
a target device coupled to the computer network or associated with the network account; and
the acquired information includes identification information associated with the target destinations;
receiving data from a data source;
filtering the received data based on information included in the received data and in the identification information;
identifying, based on the filtering, a selected target destination for receiving the filtered data; and
transmitting the filtered data to the identified selected target destination.
